(19) United States
(12) Patent Application Publication
(10) Pub. No.: US 2015/0167757 A1
(43) Pub. Date: Jun. 18, 2015

(54) TOUCH POINT ADJUSTING METHOD FOR DCT

(71) Applicants: Hyundai Motor Company, Seoul (KR); Kia Motors Corp., Seoul (KR)

(72) Inventors: Ho Young LEE, Bucheon-si (KR); Seung Sam BAEK, Jeju-si (KR)

(73) Assignees: Hyundai Motor Company, Seoul (KR); Kia Motors Corp., Seoul (KR)

(21) Appl. No.: 14/469,307

(22) Filed: Aug. 26, 2014

(30) Foreign Application Priority Data
Dec. 18, 2013 (KR) 10-2013-0157843

(51) Int. Cl. F16D 48/06; F16D 13/75

(52) U.S. Cl. CPC F16D 48/06; F16D 13/75

(57) ABSTRACT

A touch point adjusting method for a double clutch transmission, may include determining amounts of individual adjustment of first and second pressure plates and a center plate depending on temperature, determining an amount of final adjustment of a touch point in consideration of the amounts of the individual adjustment determined at the process of determining the amounts of the individual adjustment, and adjusting the touch point of a corresponding clutch based on the amount of the final adjustment of the touch point determined at the process of determining the amount of the final adjustment of the touch point.

### CROSS-REFERENCE(S) TO RELATED APPLICATION

The present application claims priority of Korean Patent Application Number 10-2013-0157843 filed Dec. 18, 2013, the entire contents of which application are incorporated herein for all purposes by this reference.

### BACKGROUND OF THE INVENTION

1. Field of the Invention

The present invention relates, in general, to a touch point adjusting method for a double clutch transmission (DCT), and more particularly, to a technology for more suitably adjusting a touch point that is a clutch characteristic of a DCT.

2. Description of Related Art

An automated manual transmission (AMT) including a double clutch transmission (DCT) is a system that can automatically control a manual transmission mechanism. Unlike a typical automatic transmission (AT) which uses a torque converter and a wet multi-plate clutch, the AMT is designed to transmit engine torque using a dry clutch in many cases.

A dry clutch is controlled using an actuator, and the actuator is typically controlled along a T-S curve that presents variations in the transmission torque of the dry clutch with respect to the stroke of the actuator.

The transmission torque of a dry clutch significantly varies depending on a variety of factors, such as the degree of wear due to the tolerance and endurance of individual constitutional elements, thermal deformation due to high temperature and changes in the coefficient of friction of a disk. It is therefore difficult to convert the transmission torque of a dry clutch into a specific form of data.

A dry clutch does not reliably reflect a change in the characteristics of the transmission torque when controlled. When the actuator is controlled insufficiently or excessively, the dry clutch may excessively slip or be subjected to an impact. There is a requirement for technology for accurately estimating the transmission torque characteristics of the dry clutch depending on the stroke of the actuator such that the transmission torque characteristics are used for control over the actuator

However, in relation to the estimation of the torque characteristics of a dry clutch, there are operation conditions and constraints for the estimation of the characteristics. Therefore, it is difficult to observe the characteristics of a dry clutch in real time. In particular, the touch point of the clutch has more constraints.

For reference, the touch point refers to the stroke of the actuator at the point of time when power starts to be transmitted to the dry clutch.

FIG. 1 shows a clutch structure of a DCT to which the present invention is applied. First and second clutches are disposed on both sides of a center plate. The first clutch includes a first clutch plate which is supplied with power by being pressed against the center plate and a first pressure plate which presses the first clutch pad against the center plate. The second clutch includes a second clutch plate and a second pressure plate. The first pressure plate presses the first clutch plate against the center plate in response to a first engagement bearing moving to the left, and the second pressure plate presses the second clutch plate against the center plate in response to a second engagement bearing moving to the left.

FIGS. 2 and 3 show the results of the test on variations in the touch points of the first and second clutches used in the DCT depending on the temperatures. FIG. 2 shows variations in the touch point of the first clutch depending on the temperature change of the first and second pressure plates, and FIG. 3 shows variations in the touch point of the second clutch depending on the temperature change of the first and second pressure plates.

Specifically, there are substantially no variations in the touch point of the first or second clutch with respect to the temperature change of the second pressure plate. In contrast, both the touch points of the first and second clutches decrease in response to the temperature of the first pressure plate rising, in which the decrease of the first clutch has a greater tendency than the decrease of the second clutch. In response to the temperature of the center plate rising, the touch point of the first clutch tends to increase, but the touch point of the second clutch tends to decrease.

In the related art, the touch point of a specific clutch is adjusted based only on the temperature of the pressure plate of the specific clutch. However, the touch point of the specific clutch is influenced by the temperature of the center plate or the temperature of the pressure plate of another clutch as described above, and these other elements may have different temperature variations. Therefore, a reliable adjustment is not conducted in the related art, which is problematic.

The information disclosed in this Background of the Invention section is only for the enhancement of understanding of the general background of the invention and should not be taken as an acknowledgment or any form of suggestion that this information forms the prior art already be known to a person skilled in the art.

### BRIEF SUMMARY

Various aspects of the present invention are directed to providing a touch point adjusting method for a double clutch transmission (DCT) which can adjust the touch points of first and second clutches by properly considering all of the variation characteristics of the touch points of the clutches depending on the temperature variations of first and second pressure plates and a center plate which are components of each clutch of the DCT. The clutch can be more properly and reliably controlled, the durability of the clutch can be improved, and shifting impacts can be prevented, thereby improving the value of the vehicle.

In an aspect of the present invention, a touch point adjusting method for a double clutch transmission, may include determining amounts of individual adjustment of first and second pressure plates and a center plate depending on temperature, determining an amount of final adjustment of a touch point in consideration of the amounts of the individual adjustment determined at the process of determining the amounts of the individual adjustment, and adjusting the touch point of a corresponding clutch based on the amount of the final adjustment of the touch point determined at the process of determining the amount of the final adjustment of the touch point.

The touch point adjusting method may further include determining gains that are applicable to the amount of the individual adjustment depending on a driving state of a vehicle between the process of determining the amount of the individual adjustment and the process of determining the amount of the final adjustment.

The touch point adjusting method may further include determining a current driving state of the vehicle before the process of determining the gains.

The gains are determined based on the current driving state of the vehicle.

The current driving state of the vehicle determined at the process of determining the current driving state of the vehicle may include at least any one of a kickdown state, a gear shift state, a departure state, and a gear engaged driving state.

According to the present invention as set forth above, it is possible to adjust the touch points of first and second clutches by properly considering all of the variation characteristics of the touch points of the clutches depending on the temperature variations of first and second pressure plates and a center plate which are components of each clutch of a DCT. The clutch can be more properly and reliably controlled, the durability of the clutch can be improved, and shifting impacts can be prevented, thereby improving the value of a vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a conceptual view illustrating the structure of a double clutch transmission (DCT) clutch.

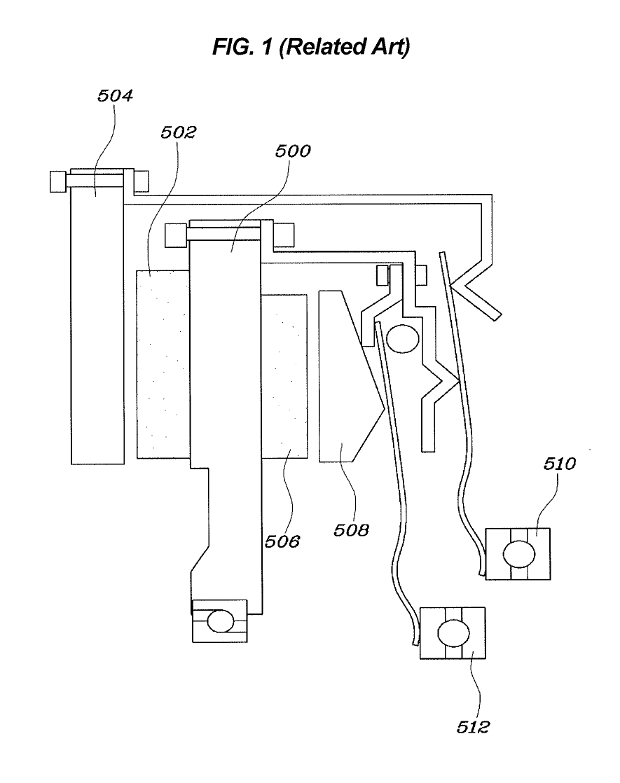

FIGS. 2 and 3 are graphs showing the results of the test on variations in the touch points of first and second clutches used in the DCT depending on the temperatures as is illustrated in FIG. 1.

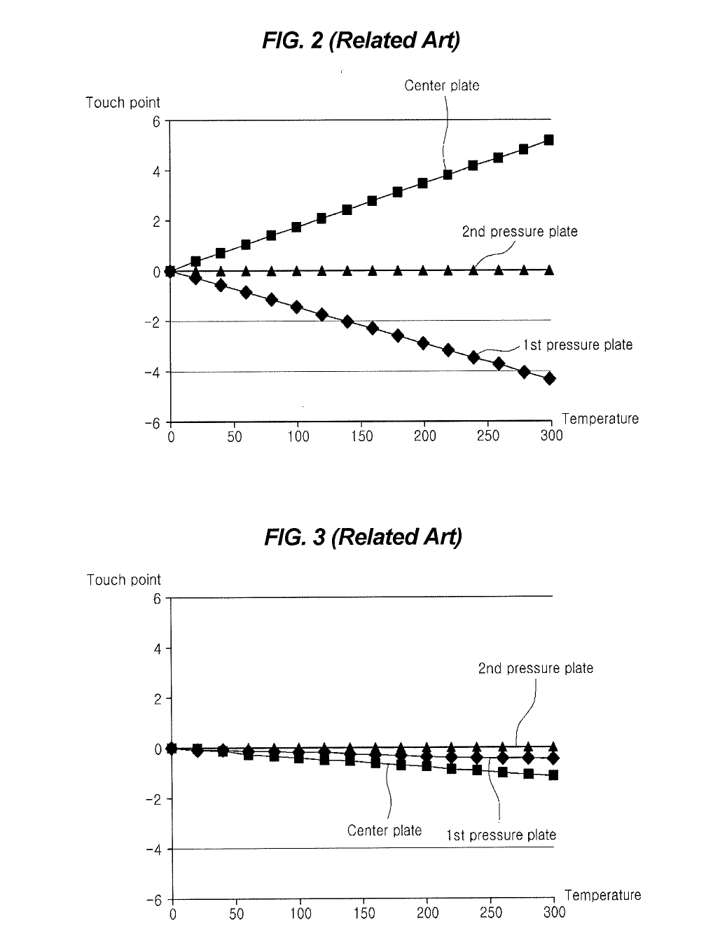

FIG. 4 is a flowchart illustrating a touch point adjusting method for a DCT according to an exemplary embodiment of the present invention.

FIG. 5 is a block diagram illustrating the exemplary embodiment of the touch point adjusting method for a DCT according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

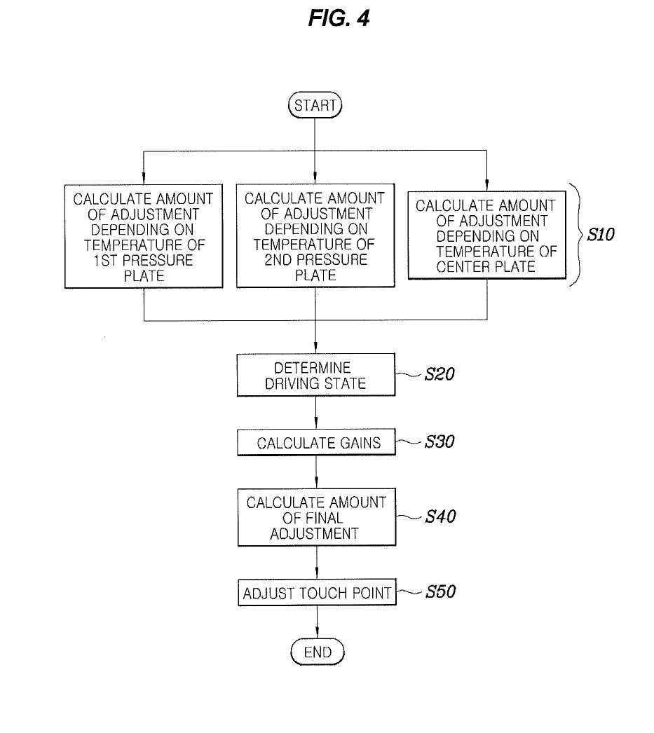

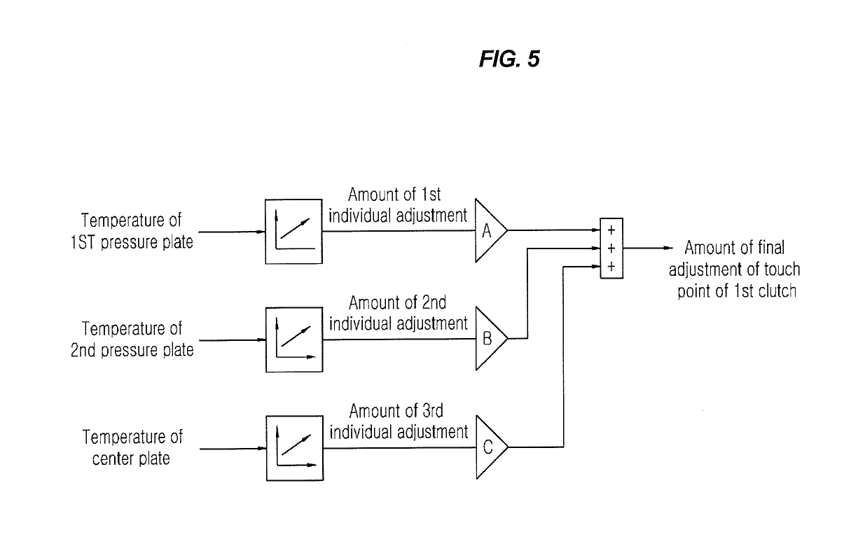

Referring to FIGS. 4 and 5, an exemplary embodiment of a touch point adjusting method for a double clutch transmission (DCT) according to an exemplary embodiment of the present invention includes: an individual adjustment calculation step S10 of calculating amounts of individual adjustment of first and second pressure plates and a center plate depending on the temperature, a total adjustment calculation step S40 of calculating an amount of final adjustment of a touch point in consideration of the amounts of individual adjustment calculated at the individual adjustment calculation step S10, and an adjustment step S50 of adjusting the touch point of a corresponding clutch based on the amount of final adjustment of the touch point calculated at the total adjustment calculation step S40.

The touch point adjusting method according to the present exemplary embodiment calculates the amounts of adjustment of the center plate and the pressure plate of the other clutch depending on the temperature together with the amount of adjustment of the pressure plate of the corresponding clutch depending on the temperature, calculates the amount of final adjustment of the touch point by synthetically considering the calculated amounts of adjustment, and then adjusts the touch point of the corresponding clutch based on the amount of final adjustment of the touch point. Accordingly, all of the variations of important factors that have an effect on the variations of the touch point can be considered, and thus the touch point can be adjusted more properly and accurately.

Of course, when the touch point is adjusted by the proper amount of adjustment as described above, the reliability of the operation of the corresponding clutch is improved to reduce the slipping of the clutch, thereby improving the durability. The improved reliability can also prevent improper impacts during gear shifting, thereby improving the quality of gear shifting. Accordingly, the improved reliability can improve the value of a vehicle.

The touch point adjusting method according to the present exemplary embodiment further includes a gain calculation step S30 between the individual adjustment calculation step S10 and the total adjustment calculation step S40. The gain calculation step S30 calculates gains that are supposed to be respectively applied to the individual amounts of adjustment depending on the driving state of the vehicle.

The touch point adjusting method according to the present exemplary embodiment further includes a driving determination step S20 of determining a current driving state of the vehicle before the gain calculation step S30.

Since the degree of influence of each amount of adjustment on the corresponding clutch varies depending on the driving state of the vehicle, this degree of influence is reflected as a gain that is calculated at the gain calculation step S30.

The driving state determined at the determination step S20 includes at least any one of a kickdown state, a gear shift state, a departure state, and a gear engaged driving state.

Therefore, the amount of final adjustment of the touch point is calculated by considering all important factors that can have an effect on variations in the touch point of the corresponding clutch depending on the current driving state of the vehicle. Application of the amount of final adjustment of the touch point that has been calculated allows the use of the touch point to be more reliable, thereby further improving the durability and the quality of gear shifting of the DCT.

For reference, FIG. 5 illustrates the method of calculating the amount of final adjustment of the touch point of the first clutch using a block diagram. The amount of first individual adjustment is calculated by applying the current temperature of the first pressure plate to a preset map of the amount of adjustment depending on the temperature variations of the first pressure plate, the amount of second individual adjustment is calculated by applying the current temperature of the second pressure plate to a preset map of the amount of adjustment depending on the temperature variations of the second pressure plate, and the amount of third individual adjustment is calculated by applying the current temperature of the center plate to a preset map of the amount of adjustment depending on the temperature variations of the third pressure plate. Gain A, gain B and gain C depending on the current driving state of the vehicle are respectively applied to the amounts of first to third individual adjustment. The amount of final adjustment of the touch point is calculated by combining the amounts of first to third individual adjustment to which the gains applied, and then the touch point of the first clutch is adjusted based on the amount of final adjustment.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A touch point adjusting method for a double clutch transmission, comprising:
determining amounts of individual adjustment of first and second pressure plates and a center plate depending on temperature;
determining an amount of final adjustment of a touch point in consideration of the amounts of the individual adjustment determined at the process of determining the amounts of the individual adjustment; and
adjusting the touch point of a corresponding clutch based on the amount of the final adjustment of the touch point determined at the process of determining the amount of the final adjustment of the touch point.

2. The touch point adjusting method according to claim 1, further comprising:
determining gains that are applicable to the amount of the individual adjustment depending on a driving state of a vehicle between the process of determining the amount of the individual adjustment and the process of determining the amount of the final adjustment.

3. The touch point adjusting method according to claim 2, further comprising:
determining a current driving state of the vehicle before the process of determining the gains.

4. The touch point adjusting method according to claim 3, wherein the gains are determined based on the current driving state of the vehicle.

5. The touch point adjusting method according to claim 3, wherein the current driving state of the vehicle determined at the process of determining the current driving state of the vehicle includes at least any one of a kickdown state, a gear shift state, a departure state, and a gear engaged driving state.
